(19) United States
(12) Patent Application Publication
(10) Pub. No.: US 2012/0176006 A1
(43) Pub. Date: Jul. 12, 2012

(54) ELECTRIC MACHINE HAVING INTEGRATED RESOLVER

(75) Inventor: Andrew Meyer, Fortville, IN (US)

(73) Assignee: REMY TECHNOLOGIES, L.L.C., Pendleton, IN (US)

(21) Appl. No.: 12/985,403

(22) Filed: Jan. 6, 2011

(51) Int. Cl. H02K 11/00; H02K 15/02

(52) U.S. Cl. 310/68 B; 29/598

(57) ABSTRACT

An electric machine that includes a stator and a rotor. The rotor includes a shaft and a lamination assembly coupled to the shaft and is configured and disposed to rotate relative to the stator, the rotor lamination assembly including a plurality of laminations that define an outer periphery having an outer surface and an inner surface. The electric machine also includes a resolver rotor coil at least partially radially inwardly disposed of the inner surface and formed in the rotor lamination assembly and a resolver stator located between the resolver rotor coil and the shaft.

### BACKGROUND OF THE INVENTION

The present invention relates to electric machines and, in particular, to electric machines having a resolver.

Electric machines such as motors and generators include a rotor that rotates relative to a stator. In the case of a motor, electrical current passing though the stator is influenced by a magnetic field developed in the rotor. The interaction of the current and the magnetic field creates an electro-motive force that causes the rotor to rotate. Certain electric motors/generators employ permanent magnets in the rotor. The permanent magnets are mounted in magnet slots formed in the rotor and that are covered by a plurality of stacked laminations.

Some electric machines are coupled to a resolver. A resolver also includes a stator and a rotor. Generally, a resolver is a type of rotary electrical transformer used for measuring degrees of rotation of a rotor. In a resolver, the stator typically houses three windings: an exciter winding and two two-phase windings (usually labeled “x” and “y”). The exciter winding is located on the top and functions as an input coil of a turning (rotary) transformer. The exciter winding couples energy to the rotor. Thus, there is no need for brushes, or limit to the rotation of the rotor. The two other windings (x and y) are on the bottom, wound on a lamination. They are configured at 90 degrees from each other. The rotor houses a coil, which is the secondary winding of the turning transformer, and a separate primary winding in a lamination, exciting the two two-phase windings on the stator.

In operation, the primary winding of the transformer, fixed to the stator, is excited by a sinusoidal electric current that, by electromagnetic induction, induces current in the rotor. This current then flows through the input coil on the rotor. This current, in turn, induces currents in the x and y windings of the stator. The x any y windings, thus, produce a sine and cosine feedback current. The relative magnitudes of the two-phase voltages are measured and used to determine the angle of the rotor relative to the stator.

In some cases, the position of the rotor of the electric machine needs to be known. In such cases, the rotor of a resolver is typically connected to the rotor of the electric machine. This adds additional parts and may lead to alignment difficulties.

### BRIEF DESCRIPTION OF THE INVENTION

Disclosed is an electric machine that includes a stator and a rotor. The rotor includes a shaft and a lamination assembly coupled to the shaft and is configured and disposed to rotate relative to the stator, the rotor lamination assembly including a plurality of laminations that define an outer periphery having an outer surface and an inner surface. The electric machine also includes a resolver rotor coil at least partially radially inwardly disposed of the inner surface and formed in the rotor lamination assembly and a resolver stator located between the resolver rotor coil and the shaft.

Also disclosed is a method of forming an electric machine. The method includes: arranging a plurality of laminations to form a rotor lamination assembly, the rotor lamination assembly including having an outer surface and an inner surface; forming a resolver rotor coil in the lamination assembly; and arranging a resolver stator in a region at least partially radially inwardly disposed from the inner surface.

### BRIEF DESCRIPTION OF THE DRAWINGS

The following descriptions should not be considered limiting in any way. With reference to the accompanying drawings, like elements are numbered alike:

FIG. 1 is a partial, cross-sectional view of an electric machine according to an embodiment of the present invention; and

FIG. 2 is an end view of a rotor according to an embodiment of the present invention.

### DETAILED DESCRIPTION OF THE INVENTION

A detailed description of one or more embodiments of the disclosed apparatus and method are presented with reference to the Figures by way of exemplification and not limitation.

In some cases, the stator of the resolver is integrated into the housing of an electric machine. In such cases, the stator of the resolver surrounds the rotor of the electric machine. Currently, the resolver rotor is placed inside of the resolver stator. This requires the resolver rotor to be a separate component mounted on the rotor shaft of the electric machine and either mechanically or electrically aligned to it. According to an embodiment of the present invention, the orientation of the resolver rotor and stator are inverted. That is, the resolver stator is located inside of the resolver rotor. In doing this, the resolver rotor can then be integrated into the rotor of the machine. This integration eliminates the resolver rotor as a separate component. To this end, the laminations of the machine rotor can include the resolver rotor windings. In one embodiment, such an inverted structure eliminates the need to align the resolver rotor to the machine rotor and reduces the piece count.

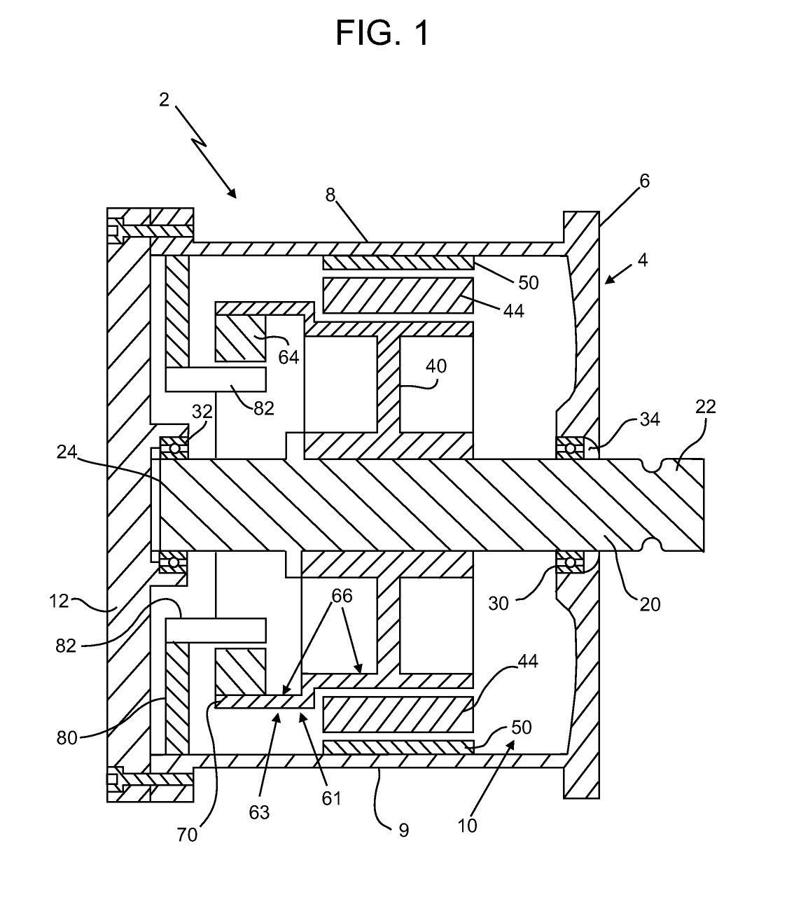

An electric machine constructed in accordance with an exemplary embodiment is indicated generally at 2 in FIG. 1. Electric machine 2 includes a housing 4 having a first end wall 6 that is joined with first and second opposing sidewalls 8 and 9 that form an interior portion 10. A second, detachable, end wall 12 is secured to first and second opposing sidewalls 8 and 9. Second end wall 12 serves as a cover that provides access to interior portion 10.

Electric machine 2 includes a shaft 20 having a first end 22 that extends through first end wall 6 to a second end 24 through an intermediate portion 26. First end 22 is rotatably supported relative to first end wall 6 through a first bearing 30 and second end 24 is rotatably supported relative to second end wall 12 through a second bearing 32. A seal 34 extends about first end 22 at first end wall 6. Seal 34 is provided to contain any fluid, such as lubricant and/or coolant, present within interior portion 10. Shaft 20 rotatably supports a hub 40 which, in turn, supports rotor windings 44. Rotor windings 44 rotate relative to a stator 50 that is supported relative to housing 4. The hub 40 can be formed of one or more laminations in one embodiment.

As illustrated, the hub 40 includes an outer periphery 61. The outer periphery includes an outer surface 63. Opposite the outer surface 63, the outer periphery 61 of the hub 40 also includes an inner surface generally indicated by reference numeral 66. It shall be understood that the inner and outer surfaces 63, 61 can be formed by a plurality of laminations in one embodiment.

In one embodiment, the hub 40 includes a resolver rotor coil 64. The resolver rotor coil 64 is located at least partially within the inner surface 66 in one embodiment. As illustrated, the resolver rotor coil 64 is located on the inner surface 66 generally at an end 70 of the hub 40. Of course, the resolver rotor coil 64 could be located at any location on the inner surface 66.

The electric machine 2 also includes a resolver stator 80. The resolver stator 80 includes three windings: an exciter winding and two two-phase windings. The windings are shown, generally, as being contained in stator windings 82. According to one embodiment, one or more of the three stator windings 82 are located within the outer periphery 61. In one embodiment, the stator windings 82 are located between the resolver rotor coil 64 and the rotor 20. In one embodiment, the resolver rotor coil 64 is arranged such that current or voltages induced therein do not interfere with either the rotor windings 44 or the stator 50.

It shall be understood that the resolver rotor coil 64 is, as illustrated, fixed to the hub 40. As such, the alignment of the resolver rotor coil 64 and the rotor 20 is guaranteed and cannot change. Voltages are applied to the stator windings 82 in the manner described above in one embodiment.

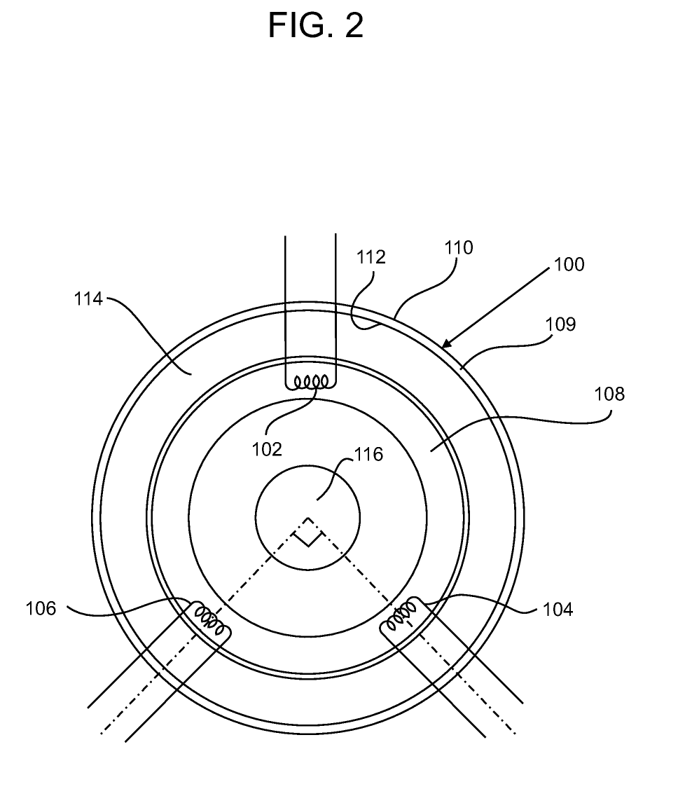

FIG. 2 shows an end view of a rotor 100 according to one embodiment of the present invention. FIG. 2 also schematically illustrates the location of stator windings 102, 104, 106 of a stator assembly 108 according to an embodiment of the present invention. The rotor 100 includes an outer periphery 109 that includes an outer surface 110 and an inner surface 112. Rotor coil 114 is located at least partially within the outer periphery 109 of the rotor 100 and outside of the rotor shaft 116. In one embodiment, the rotor coil 114 is located within a lamination assembly that makes up the rotor 100.

The windings 102, 104, 106 are illustrated as the exciter (102), and the x (104) and y (106) phase windings of a resolver stator. As such, coils 104 and 106 are arranged perpendicularly to each other. According to an embodiment of the present invention, the windings 102, 104, 106 are between the rotor shaft 116 and the rotor coil 114 and at least partially within the inner surface 66.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a stator;
a rotor including a shaft and a lamination assembly coupled to the shaft and configured and disposed to rotate relative to the stator, the rotor lamination assembly including a plurality of laminations that define an outer periphery having an outer surface and an inner surface;
a resolver rotor coil at least partially radially inwardly disposed of the inner surface and formed in the rotor lamination assembly; and
a resolver stator located between the resolver rotor coil and the shaft.

2. The electric machine of claim 1, wherein the resolver stator includes three windings.

3. The electric machine of claim 2, wherein the three windings include an exciter winding and two phase windings.

4. The electric machine of claim 1, further comprising:
rotor windings formed in the lamination assembly.

5. The electric machine of claim 4, wherein the rotor windings and the resolver rotor coil are formed in different portions of the lamination assembly.

6. A method of forming an electric machine, the method comprising:
arranging a plurality of laminations to form a rotor lamination assembly, the rotor lamination assembly including having an outer surface and an inner surface;
forming a resolver rotor coil in the lamination assembly; and
arranging a resolver stator in a region at least partially radially inwardly disposed from the inner surface.

7. The method of claim 6, further comprising:
coupling the rotor lamination assembly to a rotor shaft;
wherein arranging the resolver stator includes arranging the resolver stator between the rotor shaft and the inner surface.

8. The method of claim 6, wherein the resolver stator includes three windings.

9. The method of claim 6, wherein the three windings include an exciter winding and two phase windings.

10. The method of claim 6, further comprising forming rotor windings in the lamination assembly.

11. The method of claim 10, wherein the rotor windings and the resolver rotor coil are formed in different portions of the lamination assembly.
